(19) United States
(12) Patent Application Publication
(10) Pub. No.: US 2015/0302148 A1
(43) Pub. Date: Oct. 22, 2015

(54) METHOD AND SYSTEM FOR SECURING ELECTRONIC HEALTH RECORDS

(71) Applicant: PACid Technologies, LLC, Austin, TX (US)

(72) Inventor: Guy Fielder, Austin, TX (US)

(21) Appl. No.: 14/457,806

(22) Filed: Aug. 12, 2014

Related U.S. Application Data
(60) Provisional application No. 61/982,537, filed on Apr. 22, 2014.

(51) Int. Cl. G06F 19/00; G06F 17/30; G06F 21/60

(52) U.S. Cl. CPC G06F 19/322; G06F 21/602; G06F 17/30165

(57) ABSTRACT

A method for securing electronic health records (EHRs). The method includes receiving an EHR for a patient, obtaining patient metadata for the patient, generating a message digest using at least a portion of the patient metadata, extracting from the message digest a derived file name and a file encryption key, encrypting using the file encryption key the EHR to obtain encrypted file content, associating the encrypted file content with the derived file name and decoy file metadata to obtain an encrypted HER, and storing the encrypted EHR in a file directory.

### CROSS-REFERENCE TO RELATED APPLICATIONS

This application claims benefit under 35 U.S.C. §119(e) to U.S. Provisional Patent Application Ser. No. 61/982,537, filed on Apr. 22, 2014 and entitled, “Method and System for Filing Hiding” U.S. Provisional Patent Application Ser. No. 61/982,537 is incorporated herein by reference in its entirety.

### BACKGROUND

The computer system assists in managing (e.g., storing, organizing, and communicating) a large amount of information. Some of the information managed by a computer system is confidential. In other words, access to such information is intended to be limited. Traditional protection schemes attempt to prevent unauthorized users from accessing the confidential information by requiring that a user provide authentication credential(s), for example, a username and password, at a predefined entry point, to access an account that includes the confidential information. Protecting only the predefined entry points, however, fails to account for nefarious individuals creating other entry points by exploiting computer system vulnerabilities. For example, knowledge of a user's hardware and software system, system configuration, types of network connections, etc. may be used to create an entry point and gain access to the confidential information.

In order to prevent unauthorized access to the confidential information, the confidential information may be encrypted. Encryption is a process of transforming the clear text confidential information into an encrypted format that is unreadable by anyone or anything that does not possess a corresponding decryption key. An encryption algorithm and an encryption key are used to perform the transformation Encryption technology is classified into two primary technology types: symmetric encryption technology and asymmetric encryption technology. Symmetric encryption technology uses the same encryption key to both encrypt and decrypt confidential information. Asymmetric encryption technology uses a pair of corresponding encryption keys: this key pair share a relationship such that data encrypted using one encryption key can only be decrypted using the other encryption key of the pair.

### SUMMARY

In general, in one aspect, the invention relates to A method for securing electronic health records (EHRs) including receiving an EHR for a patient, obtaining patient metadata for the patient, generating a message digest using at least a portion of the patient metadata, extracting, from the message digest, a derived file name and a file encryption key, encrypting, using the file encryption key, the EHR to obtain encrypted file content, associating the encrypted file content with the derived file name and decoy file metadata to obtain an encrypted HER, and storing the encrypted EHR in a file directory.

In general, in one aspect, the invention relates to a computing device, comprising a processor, a memory, and software instructions stored in memory for causing the computing device to receive an EHR for a patient, obtain patient metadata for the patient, generate a message digest using at least a portion of the patient metadata, extract, from the message digest, a derived file name and a file encryption key, encrypt, using the file encryption key, the EHR to obtain encrypted file content, associate the encrypted file content with the derived file name and decoy file metadata to obtain an encrypted HER, and store the encrypted EHR in a file directory.

In general, in one aspect, the invention relates to a method for obtaining an electronic health record (EHR) for a patient, comprising obtaining a portion of patient metadata, generating a message digest using at least the portion of the patient metadata, extracting from the message digest, a derived file name and a file encryption key, obtaining an encrypted EHR from a file directory using the derived file name, and decrypting the encrypted EHR to obtain the EHR using the file encryption key.

In general, in one aspect, the invention relates to a computing device, comprising a processor, a memory, and software instructions stored in memory for causing the computing device to obtain a portion of patient metadata, generate a message digest using at least the portion of the patient metadata, extract from the message digest, a derived file name and a file encryption key, obtain an encrypted EHR from a file directory using the derived file name, and decrypt the encrypted file to obtain the EHR using the file encryption key.

### BRIEF DESCRIPTION OF DRAWINGS

FIG. 1 shows a system in accordance with one or more embodiments of the invention.

FIGS. 2 and 3 show flowcharts in accordance with one or more embodiments of the invention.

FIGS. 4A, 4B, 4C, 4D, and 4E show an example in accordance with one or more embodiments of the invention.

FIG. 5 shows a computing device in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

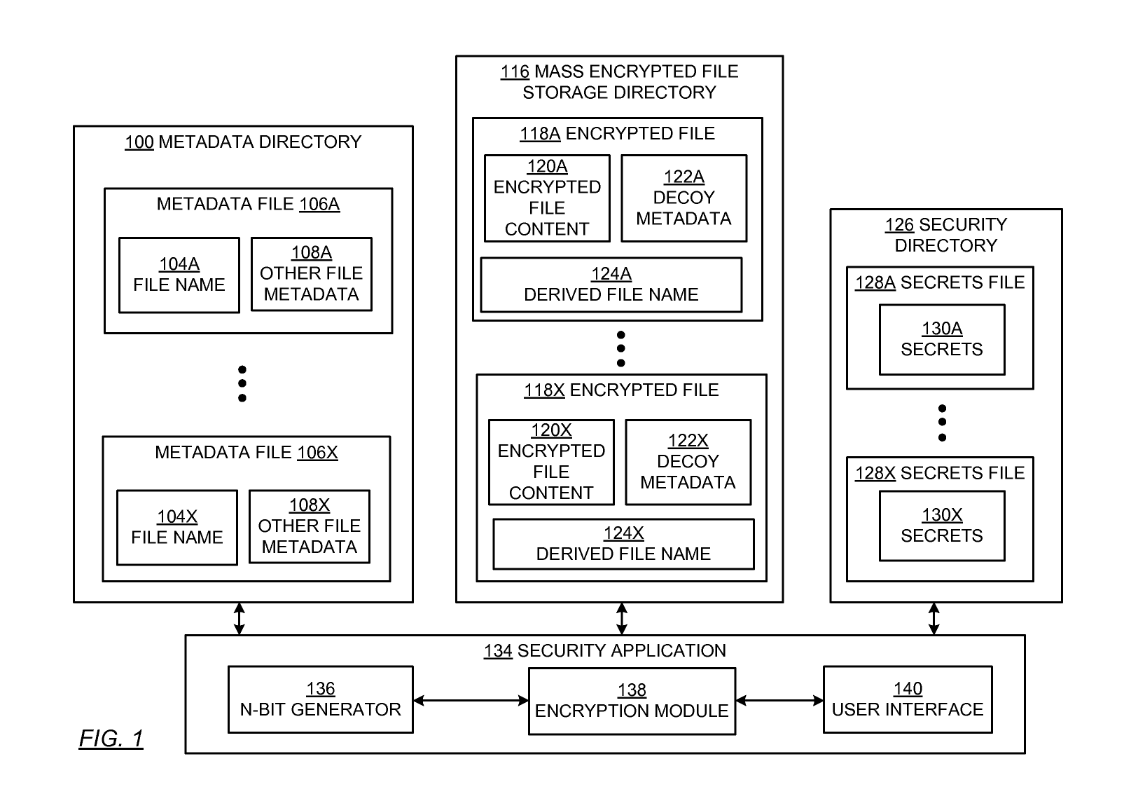

In the following description of FIGS. 1-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Encryption transforms discernible characters and text into indiscernible random bits. Very powerful computers can test encryption keys at an extremely fast rate and with each key tested scan for discernible characters. This brute force approach depends on several things: 1) they have identified and are attacking the correct encrypted file; 2) they know which encryption algorithm was used; 3) they know approximately how many bits are in the encryption key; 4) they can capture a large enough sample that uses the same algorithm and key to find discernible characters and thereby narrow the search for the correct encryption key; and, 5) the same key and algorithm are used to encrypt multiple files.

One or more embodiments of the invention may make all five of the aforementioned dependencies variables unknown. Further, implementing one or more embodiments to secure information may make a brute-force attack to obtain such information ineffective. Further, one or more embodiments of the invention leverage the multi-tenant nature of cloud storage to further enhance the protection of information stored on cloud storage

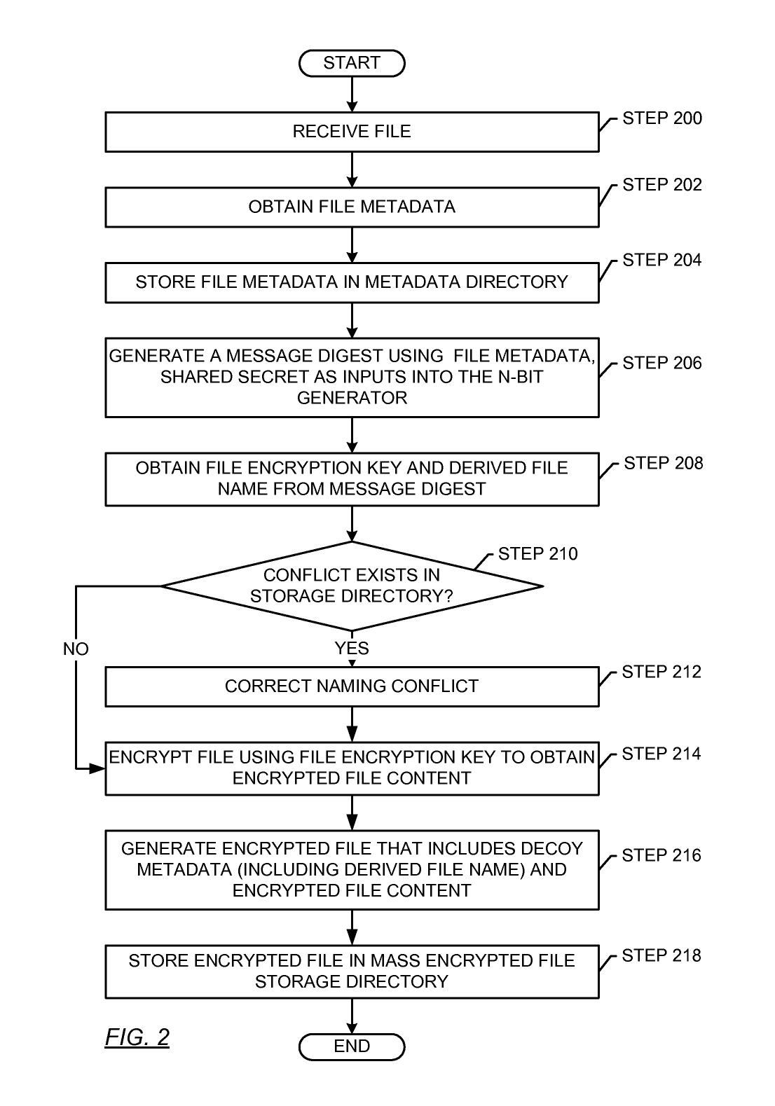

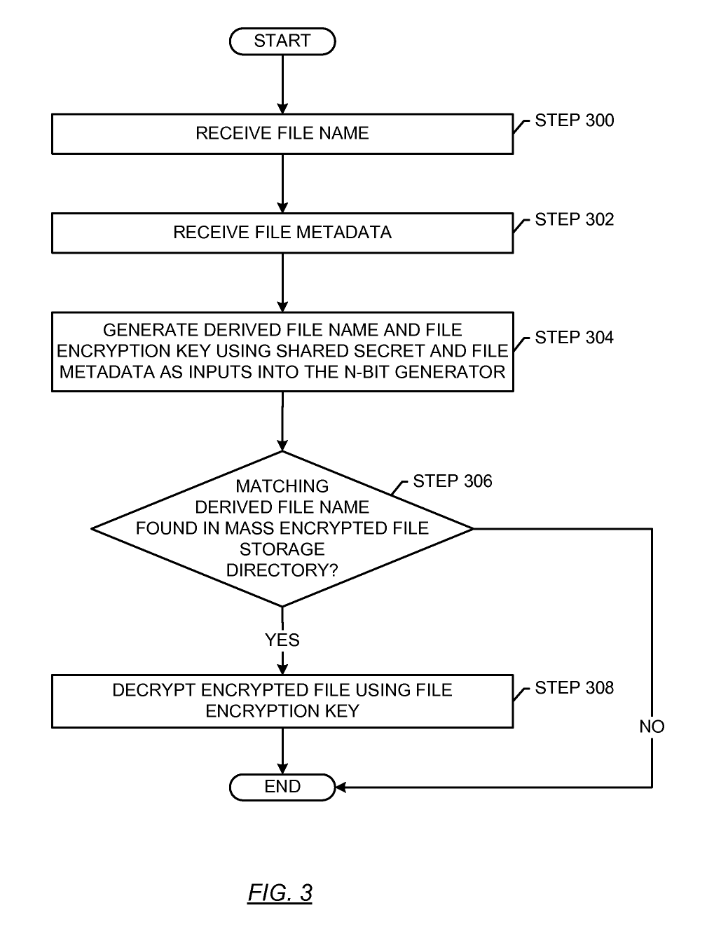

In general, embodiments of the invention relate to securing files stored on storage mediums or storage platforms (collectively, “multi-tenant storage”) that enable multiple members to store data. In one embodiment of the invention, the members are configured to perform functionality described in FIG. 2 and/or FIG. 3 in order to access the multi-tenant storage. Further, one or more embodiments of the invention enable information to be stored on multi-tenant storage by one member and retrieved by another member.

In one embodiment of the invention, each file includes at least the following components: (i) file metadata that includes a file name (e.g., 104A, 104X in FIG. 1) and other file metadata (e.g., 108A, 108X in FIG. 1); and (ii) file content. Each component is discussed below.

In one or more embodiments of the invention, the file name is the unique identifier of the file. The file name is typically assigned by the file creator (owner) or a variant as defined by the file manager (“Trip to Cancun.docx” or it might be “Trip to Cancun (2).docx”). In other words, the file name is the clear text unique identifier as used by a file management system such as the Microsoft or Apple File Manager.

In one or more embodiments of the invention, the other file metadata includes information about the file. Specifically, the other file metadata may include a created timestamp, an accessed timestamp, a modified timestamp, and a file size. The created timestamp specifies when the file was created. If the file is a copy of another file, then the created timestamp specifies when the copy was created. Similarly, the accessed timestamp specifies when the file was last accessed by the user or the program. For example, the accessed timestamp may correspond to the last time in which the file was opened. The modified timestamp specifies when the file was last modified. Specifically, the modified timestamp specifies when a change was saved to the file. The file size provides the size of the file. Specifically, the file size may specify, for example, the amount of physical storage space required to store the clear text file. The file metadata may include other information about the file without departing from the invention.

In one or more embodiments of the invention, the file content includes that data that is being stored. The file content, like the file metadata may be stored in a binary format. The file content may include one or more types of content, for example, the file content may be text, audio content, audiovisual content, graphics, images, etc.

In one embodiment of the invention, a member is a computing device. In one embodiment of the invention, a computing device is any physical or virtual device that may be used to perform embodiments of the invention. The physical device may correspond to any physical system with functionality to implement one or more embodiments of the invention. For example, the physical device may be implemented on a general purpose computing device (i.e., a device with a processor(s) and an operating system) such as, but not limited to, a desktop computer, a laptop computer, a gaming console, a mobile device (e.g., smart phone, tablet, netbook, personal digital assistant, gaming device).

Alternatively, the physical device may be a special purpose computing device that includes an application-specific processor(s)/hardware configured to only execute embodiments of the invention. In such cases, the physical device may implement embodiments of the invention in hardware as a family of circuits and limited functionality to receive input and generate output in accordance with various embodiments of the invention. In addition, such computing devices may use a state-machine to implement various embodiments of the invention.

In another embodiment of the invention, the physical device may correspond to a computing device that includes both a general purpose processor(s) and an application-specific processor(s)/hardware. In such cases, one or more portions of the invention may be implemented using the operating system and general purpose processor(s) and one or more portions of the invention may be implemented using the application-specific processor(s)/hardware. In one non-limiting example, the general purpose device may be a personal computer, smart phone, tablet, personal digital assistant, gaming device, etc. and the application specific hardware may be a token or extra device that connects to the general purpose device via a wired or wireless interface. In one embodiment of the invention, a portion of the security application may be executing on a user's personal computer and another portion of the security application may be executing on the user's phone. By placing a portion of the security application on the user's phone, the user may continue to use embodiments of the invention while travelling but at the same time not require the user to keep or take their personal computer with them when they travel. Other combinations may occur without deviating from the scope of this invention.

The virtual device may correspond to a virtual machine. Broadly speaking, the virtual machines are distinct operating environments configured to inherit underlying functionality of the host operating system (and access to the underlying host hardware) via an abstraction layer. In one or more embodiments of the invention, a virtual machine includes a separate instance of an operating system, which is distinct from the host operating system. For example, one or more embodiments of the invention may be implemented on VMware® architectures involving: (i) one or more virtual machines executing on a host computer system such that each virtual machine serves as host to an instance of a guest operating system; and (ii) a hypervisor layer serving to facilitate intra-host communication between the one or more virtual machines and host computer system hardware. Alternatively, one or more embodiments of the invention may be implemented on Xen® architectures involving: (i) a control host operating system (e.g., Dom 0) including a hypervisor; and (ii) one or more VMs (e.g., Dom U) executing guest operating system instances. The invention is not limited to the aforementioned exemplary architectures. VMware® is a registered trademark of VMware, Inc. Xen® is a trademark overseen by the Xen Project Advisory Board.

As discussed above, a member, which is part of a group, is a computing device that may access shared files stored by other members of the group in accordance with one or more embodiments of the invention. Each of the members may be used by, for example, an individual, a business entity, a family, any other entity, or any combination thereof. For example, a group may have members John Smith's computing device and Jane Doe's computing device. As another example, a group may have members John Smith's smart phone, John Smith's personal computer, and John Smith's gaming console. As another example, a group may have members John Smith's computing device, Jane Smith's computing device, and the servers of the Smith's financial advisors. Other possible groups may exist without departing from the scope of the invention.

In one or more embodiments of the invention, each member is part of one or more groups, where each group has one or more members. Further, each member of a group can share files with other members of the same group.

In one or more embodiments of the invention, each member creates a secrets file that has secret(s). The name of the secrets file and the secret is generated by an n-bit generator. The secret(s) is used to secure files accessible to the members of the group.

FIG. 1 shows a system in accordance with one or more embodiments of the invention. As shown in FIG. 1, the system includes a security application (134), a metadata directory (100), a mass encrypted file storage directory (116), and a security directory (126). Each of these components is discussed below.

In one or more embodiments of the invention, each member (not shown) includes a security application (134). The security application (134) on each member may be an instance of the same application, different versions of the same application, or different applications. Further, the security application may correspond to a complete program product or a programming module of another application. For example, the security application may be a part of and provide security for banking and/or commerce applications. In one or more embodiments of the invention, the security application (134) includes an n-bit generator (136), an encryption module (138), and a user interface (140). Each of the components of the security application (134) may be implemented in hardware, software, firmware, or a combination thereof. The components of the security application are discussed below.

In one or more embodiments of the invention, an n-bit generator (136) includes functionality to receive and process one or more inputs to generate a message digest. A message digest is a string of characters, which may be represented as a bit-string, in accordance with one or more embodiments of the invention. Further, the n-bit generator includes functionality to generate a deterministic and repeatable message digest, which appears pseudo-random or random, in accordance with one or more embodiments of the invention. A pseudo-random output (e.g., message digest) is output that is repeatable and predictable but appears random. Specifically, in one or more embodiments of the invention, although the message digest is repeatable and calculable when the inputs and the operations performed by the n-bit generator (136) are known, the message digest appears random. The apparent randomness may be with respect to someone who knows or does not know the inputs in accordance with one or more embodiments of the invention. Alternatively, or additionally, the apparent randomness may be with respect to someone who does not know the operations performed by the n-bit generator in accordance with one or more embodiments of the invention. In one or more embodiments of the invention, the message digest is deterministic in that a single output exists for a given set of inputs. Moreover, the message digest may be a fixed length. In other words, regardless of the input length, a similar n-bit generator (136) may produce a message digest with a fixed length.

The number of bits in the input to the n-bit generator may be different or the same as the number of bits in the output produced by the n-bit generator. For example, if the n-bit generator accepts n number of bits for input and produces m number of bits for output, m may be less than, equal to, or greater than n. Multiple iterations of the n-bit generator may be performed to construct additional multiple message digests. These additional message digests or multiple message digests may be combined or not combined as defined by the security application.

Further, the n-bit generator (136) includes functionality to generate a deterministic message digest. Specifically, the n-bit generator (136) has the following two properties. First, the n-bit generator (136) generates the same message digest when provided with the same input(s). Second, the n-bit generator generates, with a high probability, a different message digest when provided with different input(s). For example, a single bit change in the input may result in a significant change of the bits in the resulting message digest. In the example, the change may be fifty percent of the bits depending on the type of n-bit generator used. However, a greater percentage or less percentage of bits may change without departing from the scope of the invention.

The n-bit generator (136) may include multiple sub-routines, such as a bit shuffler (not shown) and a hash function (not shown). In one or more embodiments of the invention, the bit shuffler includes functionality to combine multiple inputs into a single output. Specifically, the bit shuffler applies a function to the bit-level representation of inputs to generate a resulting set of output bits. The output of the bit shuffler may appear as a shuffling of bits in each of the inputs and may or may not have the same ratio of 1's to 0's as the input. In one or more embodiments of the invention, the bit shuffling by the bit shuffler has a commutative property. In other words, the order that inputs are provided to the bit shuffler does not affect the output. For example, consider the scenario in which the inputs are input X, input Y, and input Z. Bit shuffling on input X, input Y, and input Z produces the same output as bit shuffling on input Y, input Z, and input X.

In one embodiment of the invention, the bit shuffler may correspond to any function or series of functions for combining inputs. For example, the bit shuffler may correspond to the XOR function, the multiplication function, an addition function, or another function that may be used to combine inputs. As another example, the security application with the bit shuffler may correspond to a function that orders the inputs and then uses a non-commutative function to generate an output. The bit shuffler may correspond to other mechanisms for combining multiple inputs without departing from the scope of the invention.

In one or more embodiments of the invention, a hash function is a function that includes functionality to receive an input and produce a pseudo-random output. In one or more embodiments of the invention, the hash function may include functionality to convert a variable length input into a fixed length output. For example, the hash function may correspond to GOST, HAVAL, MD2, MD4, MD5, PANAMA, SNEERU, a member of the RIPEMD family of hash functions, a member of the SHA family of hash functions, Tiger, Whirlpool, S-Box, P-Box, any other hash function, or combination thereof.

Although the above description discusses the use of the bit shuffler prior to the hash function, in one or more embodiments of the invention, the hash function operations may be performed prior to the bit shuffler operations. For example, the hash function may be performed separately on each of the inputs to create hashed inputs. The hashed inputs may then be combined by the bit shuffler. Alternatively, the bit shuffler may be first performed on the inputs to create a single intermediate result before the intermediate result is provided to the hash function. The intermediate result may be stored to be used later to create subsequent message digests.

Further, in one or more embodiments of the invention, the n-bit generator includes a random character generator, such as a random number generator. The random character generator includes functionality to generate a random string of characters of a specified length. The n-bit generator may use the random character generator, for example, to generate the derived file names (e.g., 124A, 124X) and/or the decoy metadata (e.g., 122A, 122X).

The n-bit generator (136) is operatively connected to an encryption module (138) in accordance with one or more embodiments of the invention. An encryption module (138) includes functionality to manage the encryption and decryption of information for the computing device. In one or more embodiments of the invention, the encryption module may be external to the security application (134) and, in such embodiments, be implemented as separate software application or, alternatively, be implemented in hardware. In the scenario in which the encryption module is implemented in a separate software application, the encryption module may be configured to use idle processors (e.g., CPUs, GPUs, etc.) on the member, where such processors are idle at the time the encryption module is performing one or more functions in accordance with one or more embodiments of the invention. In another embodiment of the invention, in the scenario in which the encryption module is implemented in a separate software application, the encryption module may be configured to utilize specialized hardware and/or dedicated hardware.

For example, the encryption module may include functionality to receive information, request one or more message digests from the n-bit generator (136), extract an encryption key from the one or more message digests, and/or encrypt the information using the encryption key. Alternatively, or additionally, the encryption module (138) may include functionality to receive encrypted information, request one or more message digests from the n-bit generator (136), extract an encryption key from the one or more message digests, and/or decrypt the encrypted information using the encryption key.

In one or more embodiments of the invention, the encryption module (138) is identically configured across all members of a group to request the same number of message digests. The configuration may be based, for example, on the type of communication, the encryption algorithm, and/or the type of data to be extracted from the message digest.

The encryption module (138) implements one or more encryption algorithms. In one or more embodiments of the invention, the encryption algorithm includes functionality to transform information in a clear text format into an encrypted format that is unreadable by anyone or anything that does not possess a corresponding encryption key. Unreadable information is a form of clear text that is incomprehensible by humans (e.g., alphanumeric strings that appears to be random or pseudo-random). In one or more embodiments of the invention, the encryption module may be configured to encrypt a file using any number of encryption keys. For example, a file may be encrypted using a first encryption key to obtain a first encrypted file. The encryption module may then encrypt the first encrypted file with a second encryption key to obtain a second encrypted file. In the above non-limiting example, the first encryption key may be the same or different than the second encryption key. In one or more embodiments of the invention, different encryption algorithms may be used each time a given file is encrypted. For example, a first encryption key and a first encryption algorithm may be used to encrypt a file in order to obtain a first encrypted file. A second encryption key and a second encryption algorithm may be applied to the first encrypted file in order to generate a second encrypted file.

By way of another example, the encryption algorithm may correspond to Data Encryption Algorithm (DEA) specified in the Data Encryption Standard (DES), Triple DES, Advanced Encryption Standard (AES), FEAL, SKIPJACK, any other encryption algorithm, or any combination thereof. In one or more embodiments of the invention, the encryption module implements only symmetric encryption algorithm(s).

In one embodiment of the invention, the encryption module implements an encryption algorithm on a file (or on an encrypted file if the file is encrypted two or more times (as discussed above)). A file stores electronic information. The file may be in clear text format or encrypted format. In clear text format, a file is readable by anyone or anything. When in encrypted format, a file is unreadable by anyone or anything that does not possess the corresponding encryption key. For example, a file that is a clear text Microsoft Word document may be encrypted to become unreadable. By way of another example, a file may be of type portable document formatted (PDF), extensible markup language (XML), or Microsoft Word.

Although not shown in FIG. 1, the encryption module (138) may also include or be operatively connected to an algorithm selector table (not shown). An algorithm selector table is a logical association between encryption algorithms and an algorithm identifier. The algorithm identifier may be, for example, a numeric, binary, or another such value. In one or more embodiments of the invention, all algorithm identifiers in a range are present. For example, the algorithm identifier may be a range of integers (e.g., 0 . . . 15), a sequence of binary values (e.g., 000, 001, 010, . . . 111). Further, the same encryption algorithm may be associated with multiple algorithm identifiers in the table. For example, “0” may correspond to AES, “1” may correspond to Triple DES, “2” may correspond FEAL, and “3” may correspond to Triple DES. The use of the term, “table”, is only to denote a logical representation, various data structures may be used to implement the algorithm selector table without departing from the scope of the invention.

Further, in one or more embodiments of the invention, the association between the encryption algorithm identifiers and the encryption algorithms is not based on a pre-defined ordering of encryption algorithms. Specifically, the association may be randomly defined.

The use of the term, “table”, is only to denote a logical representation, various implementations of the algorithm selector table may be used without departing from the scope of the invention. For example, the algorithm selector table may be implemented in computer instructions using a series of conditional statements. Specifically, when a conditional statement is satisfied, the code corresponding to the implementation of the encryption algorithm is executed. By way of another example, the algorithm selector table may be implemented as a data structure that associates the consecutive encryption algorithm identifiers with identifiers used by the security application for each of the encryption algorithms. The above are only a few examples of possible implementations for the algorithm selector table and not intended to limit the scope of the invention.

Further, all members associate the same encryption algorithm identifiers with the same corresponding encryption algorithms. For example, if one member associates “0” with AES, “1” with Triple DES, “2” with FEAL, and “3” with Triple DES, then the remaining members associates “0” with AES, “1” with Triple DES, “2” with FEAL, and “3” with Triple DES. Further, all members may or may not use the same implementation of the algorithm selector table when associating with other groups.

In one or more embodiments of the invention, the algorithm selector table includes separate entries for each encryption algorithm and key length pair. In one or more embodiments of the invention, the encryption module may identify the encryption algorithm from the algorithm selector table and use the key length associated with the encryption algorithm to extract the appropriate number of bits for the encryption key. For example, an entry may exist for Blowfish with an encryption key length 256 bits and a separate entry may exist for Blowfish with an encryption key length of 384 bits. In the example, if the first entry is specified in the algorithm selector bits of the message digest (discussed below), then 256 bits are extracted from the message digest(s) for the encryption key. Alternatively, in the example, if the second entry is specified, then 384 bits are extracted from the message digest for the encryption key.

Further, each entry in the algorithm selector table may include a starting bit value. The starting bit value may be used to identify a first secret to use in the secrets repository or a starting bit for the encryption key in the message digest.

Alternatively, although not shown in FIG. 1, the system may include a key length table. The key length table may specify an identifier with a corresponding encryption key length. Similar to the algorithm selector table, multiple different possible implementations of the key length table may be used without departing from the scope of the invention. Further, all members of the group have the associations between key length identifiers and key lengths, but may not have the same implementation of key length table. For example, “1” may be associated with “256 bits”, 2 may be associated with “128 bits”, etc.

In one or more embodiment of the invention, when a key length table is used, the algorithm selector table may be used to specify the encryption algorithm, and the key length table may be used to specify the number of bits in the encryption key. Specifically, a key length field (discussed below) in the message digest may index the corresponding entry in the key length table. In one or more embodiments of the invention, if the specified encryption algorithm does not allow for variable key length, then the key length field in the message digest is ignored.

Continuing with the security application (134), in one or more embodiments of the invention, the user interface (140) includes functionality to communicate with a user of the computing device. For example, the user interface (140) may include functionality to guide a user through configuring the security application to communicate with one or more groups of which the computing device is a member. Further, the user interface (140) may include functionality to inform a user when another member of a group is requesting to share files and provide the user with the option of allowing file sharing with the user's computing device. The user interface (140) may include hardware and/or software components, such as information boxes, menu buttons, drop down boxes, input boxes, hardware lights, hardware buttons, speaker, a vibrating alert and/or other user interface components.

Further, a portion of the security application (134) may be remote from the computing device. For example, a portion of the security application may be stored on an external storage device. As another example, an external device that is connected to the computing device may be configured to process and display a user interface for the security application (134) executing on the computing device.

Although not shown in FIG. 1, the security application may include an application programming interface (API). The security application may be configured to communicate with other applications executing on the same or different computing devices using the API. Thus, for example, the API of member A may include functionality to communicate via the network with member B's security application. As another example, the API may include functionality to receive an encrypted format of a file and provide a clear text format of the file to another application executing on member A. Conversely, the API may include functionality to receive, from another application on member A, a clear text format of a file and provide an encrypted format of the file to another application executing on member A.

In one or more embodiments of the invention, the security application (134) includes functionality to access and use a security directory (126). A security directory (126) is located within a file system for storage of the secrets file (e.g., 128A, 128X). Alternatively, the file system merely includes an access point for the security directory, which is stored on an external physical storage medium that is accessible via the file system (e.g., the external physical storage medium is mounted to the file system). In one or more embodiments of the invention, the security directory (126) may include a partitioning of files for each group of which the user is a member.

In one embodiment of the invention, the security directory (126) (or portions thereof) is located on an external device that is accessible to the security application by a wired or wireless interface. Examples of external devices include, but are not limited to, a mobile phone, a smart phone, a personal digital assistant, a portable gaming device, a memory device (e.g., any device with non-volatile memory) with a contactless or wireless interface (e.g., a BlueTooth Interface), a memory device (e.g., any device with non-volatile memory) with a contact or wired interface (e.g., a Universal Serial Bus (USB) interface or any other type of physical interface), etc.

Although FIG. 1 shows the security directory (126) as only including the secrets file (e.g., 128A, 128X), the security directory (126) may include other files without departing from the scope of the invention. For example, the security directory (126) may include general files for the member, general files for a computer system (not shown) connected to the member, configuration files for the security application (134), and/or any other files. Further, the other files may or may not be in the same partition in the security directory as the secrets file (e.g., 128A, 128X).

The secrets file (e.g., 128A, 128X) is a file for storing secrets (e.g., 130A, 130X). Secrets in the secrets file (e.g., 128A, 128X) are shared secrets. Shared secrets (e.g., 130A, 130X) correspond to data known only to the members of the group. Specifically, the security application (134) of each member of the group independently generates the secrets (e.g., 130A, 130X) using an n-bit generator (136) and the same group agreed seed as inputs to the n-bit generator (136). The group agreed seed may be any password, passphrase, or series of characters agreed upon by members of the group or their corresponding users. For example, the group agreed seed may be “the cow jumped over the moon,” “#8$#DsaVA(@12w @,” or any other collection of Hexadecimal (also referred to as “Hex”) or ASCII characters (e.g., symbols and/or alphanumeric characters). Alternately, an administrator can provide the shared secrets in a manner where none of the members knows anything about the secrets other than the group name to identify the shared secrets file.

In one or more embodiments of the invention, because each secret is generated by the n-bit generator (136), each secret is a pseudo-random bit string or m-bit message digest. For example, when displayed in textual-based format, each secret appears as random string of characters (e.g., ASCII or Hex symbols or any other character set used to represent characters).

In one or more embodiments of the invention, each security application generates the same set of secrets (e.g., 130A, 130X). Each secret (e.g., 103A, 103X) in the secrets file may be associated with a unique secret identifier. The unique secret identifier may be a consecutive integer specifying when the secret was generated. For example, the first generated secret may be associated with the number one, while the second generated may be associated with the number two, etc. The consecutive integer may be explicitly or implicitly associated with the secret. For example, the number one may be stored in the secrets file (e.g., 128A, 128X) with the first generated secret. Alternatively, the first generated secret may be in the first position in the secrets file to indirectly associate the first generated secret with the first integer. In another embodiment of the invention, a single m-bit message digest may include multiple secrets. In this scenario, the security application may store the m-bit message digest in a secrets file and then use one or more of the secrets in the m-message digest for various operations (as described below). In one or more embodiments of the invention, the specific secret(s) to be used to perform an operation may be conveyed by providing the entire m-bit message digest, for example to the n-bit generator, along with one or more labels that identify which secret(s) from the m-bit message digest should be used. Upon receipt of the m-bit message digest along with the label(s), the recipient may map each of the labels for a bit range within the m-bit message digest. Based on the mapping, the recipient may extract the appropriate secrets from the m-bit message digest. For example, consider a scenario in which the m-bit message digest is 2048 bits and that the 2048 bit message digest is divided into (2) two 1024-bit secrets or (4) four 512-bit secrets, or (8) eight 256-bit secrets and so on. When a secret one is to be used the m-bit message digest along with the label one is provided. Similarly, if secrets one and three are to be used, then the m-bit message digest along with the labels one and three are provided.

Secrets (e.g., 130A, 130X) in the secrets file (e.g., 128A, 128X) are each associated with a given group and may be further organized according to the clear text file format of a file to be encrypted. For example, secrets used to encrypt portable document formatted (PDF) files may be different than secrets used to encrypt extensible markup language (XML) files.

In one or more embodiments of the invention, each shared secret may include one or more static secret(s), one or more dynamic secret(s), or both static secret(s) and dynamic secret(s). The static secret(s) may remain unchanged throughout the lifetime of the group in accordance with one or more embodiments of the invention. For example, a static secret may be used to recover secure communications by providing a new set of secrets when the members of the group lose synchronization with regards to the dynamic secrets. In contrast, a dynamic secret may periodically change, such as at the end of each communication session or prior to beginning a communication session.

In one or more embodiments of the invention, a communication session may be a set (or combination) of related communications (e.g., Internet, related short messaging service messages (SMS), related emails, chat messages, or other related communications). The communications may be deemed to belong to a communication session when, for example, (i) the communications are between members of a group, (ii) the communications are between members of a group related to a particular subject, (iii) the communications are between members of a group using one or more communication channel(s) (e.g., email, SMS, chat, etc.) Alternatively, or additionally, a communication session may correspond to a set of communications starting at a first time and having a duration of a pre-defined amount of time. The pre-defined amount of time may be defined, for example, according to the amount of time after the last communication is sent and/or received.

In one or more embodiments of the invention, secrets (e.g., 130A, 130X) are protected in the secrets file. The protection of the secrets (e.g., 130A, 130X) may be performed by encrypting the file. Specifically, the secrets file (e.g., 128A, 128X) may have an encryption key (not shown) associated with the secrets file (e.g., 128A, 128X), such that only the encryption module (138) can decrypt the file. Protection may further include making the secrets (e.g., 130A, 130X) inaccessible to the member having the security directory (126). Specifically, the member (or user of the member) may be unable to identify the secrets (e.g., 130A, 130X) or even the secrets file (e.g., 128A, 128X). By hiding the secrets (e.g., 130A, 130X) even from the member (and the user of the member) having the security application (134) and the security directory (126), the secrets (e.g., 130A, 130X) are highly unlikely to be compromised by the member (or the user of the member).

The security directory (126) is typically located on the same computing device or storage medium as the metadata directory (100) and any encrypted files (118A, 118X). Further, the metadata directory is typically located on a computing device or storage medium that does not include any encrypted files (118A, 118X).

Continuing with the discussion of FIG. 1, the security application (134) includes functionality to access and use a metadata directory (100). The metadata directory (100) includes metadata files (106A, 106X). Each metadata file include file metadata for a given file. Specifically, as shown in FIG. 1, each metadata file includes a file name (e.g., 104A, 104X) and other file metadata (108A, 108X) (described above). In one embodiment of the invention, the metadata files may be stored in encrypted form. In one embodiment of the invention, the metadata directory (100) only includes the file name and other file metadata for a file but does not include the file content for the file.

In one embodiment of the invention, the metadata file in the metadata directory may also include other information (excluding file content). In one embodiment of the invention, once a file has been encrypted, once or multiple times, it is typically no longer searchable. However, a group (described above) may identify search parameters (tags) and place those parameters in the file metadata (the search parameters may be in any format, including, but not limited to, XML, HTML, any other format that is used for tagging purposes, any other markup language format, or any combination thereof). A group may define their own set of search parameters or an industry (or any other consortium of entities) can agree on search parameters. For example, if the file includes patient medical information, then the search parameters may be medical procedure codes, insurance codes, etc. Thereafter, the metadata file database directory may still be searched for specific parameters without exposing sensitive information during the search. The search parameters may be manually input/associated with the file metadata and/or be automatically extracted from the file (i.e., the file obtained in Step 200). The extraction of search parameters may be performed using any known or future discovered mechanism without departing from the invention.

In one embodiment of the invention, at least one of the search parameters associated with a given metadata file includes a copy of content from the corresponding file (i.e., the file obtained in Step 200). For example, if the file content is a text document, natural language processing techniques may be used to identify four or five key terms in the document. In another example, if the file includes a summary section or an abstract, the entire contents of the summary and/or abstract may be included in the search parameters. In another example, if the file is an electronic health record, then the insurance and/or procedure codes may be extracted from the file and included within the search parameters.

Alternatively, or additionally, in one embodiment of the invention, at least one of the search parameters associated with a given metadata file is derived from information in the corresponding file (i.e., the file obtained in Step 200), where the derived search parameter is not a copy of content that is actually present within the file. In another example, if the file is an electronic health record and no insurance or procedure codes are present in the file, then the text of the electronic health record may be analyzed and, based on the result of the analysis, one or more insurance and/or procedure codes may be included within the search parameters.

Additionally, or alternatively, the metadata file may also include a constant value(s) generated by the security application (or any other application). For example, the constant value(s) may be generated using the random number generator (discussed above). In such cases, the constant value(s) becomes part of the file metadata for the file that is stored in the metadata directory. In one embodiment of the invention, the constant value is a string of alphanumeric characters that is associated with a particular file and a group of members. The constant value is generated for a group of members to be used with a particular file. In one embodiment of the invention, the constant value is agreed upon by members of a group prior to processing the file. In another embodiment of the invention, the constant value is randomly generated prior to processing the file. For example, a random alphanumeric character generator may be used to generate the constant value “A5RE34GHV.” In the example, the constant value is associated with a clear text file titled “Trip to Shanghai” and may be used to open only that particular file. A constant value might be the group name, random character(s) and a date and time stamp.

The constant value(s) is not part of the original file (i.e., the file that is encrypted in order to generate the encrypted file content) (see FIG. 2, Step 214). In one embodiment of the invention, the security application creates a constant value input and stores it within the file metadata for the file, for example, as an additional metadata field. In one embodiment of the invention, the aforementioned constant value may also be stored in other locations without departing from the invention. Further, multiple copies of the constant value may be stored in different locations by the security application.

In one embodiment of the invention, once the file metadata (including the file name and other file metadata) is added to the metadata directory, the file metadata does not change. Said another way, the file metadata that is stored in the metadata directory for a given file is the file metadata of the file at the time the file metadata was stored in the metadata directory. In one or more embodiments because the file metadata stored in the metadata directory for a given file does not change, the Security Application (or a component within the Security Application) may use all or a portion of the metadata in Step 206 in FIG. 2.

In one embodiment of the invention, if a given file is modified (e.g., file content is changed, file name is changed, or file metadata is changed), then for the purposes of this invention, the resulting modified file is considered a different file as compared with the unmodified file. For example, consider a scenario in which a first version of the file is created (V1). Subsequently, the file name of V1 is changed, the resulting modification generates a second version of the file V2. For the purposes of this invention, V1 and V2 are treated as different files even though they may have the same file content.

In one embodiment of the invention, the metadata directory (100) (or portions thereof) is located on an external device that is accessible to the security application. Examples of external devices include, but are not limited to, a mobile phone, a smart phone, a personal digital assistant, a portable gaming device, a memory device (e.g., any device with non-volatile memory) with a wireless or contactless interface (e.g., a BlueTooth Interface), a memory device (e.g., any device with non-volatile memory) with a wired or contact interface (e.g., a Universal Serial Bus (USB) interface), etc.

Continuing with the discussion of FIG. 1, the security application (134) includes functionality to access and use a mass encrypted file storage directory (116). The mass encrypted file storage directory (116) (described below) is configured to share encrypted files (e.g., 118A, 118X) and corresponding information such as derived file name (e.g., 124A, 124X) and decoy metadata (e.g., 122A, 122X). Each component is discussed below.

An encrypted file (e.g., 120A, 120X) is a file that is encrypted. Encrypting a file to obtain an encrypted file may include encrypting the entire file (i.e., the file name, file content, and file metadata) or only encrypting a portion of the file (e.g., the file content). Specifically, the encrypted file is a file that may be further encrypted or decrypted by the encryption module (138). The encrypted file may be decrypted and/or further encrypted using one or more encryption keys (not shown). In one embodiment of the invention, the encryption key is extracted from the result of the n-bit generator (136). For example, the encrypted file may be encrypted using the AES algorithm with a 128-bit encryption key extracted from a message digest.

In one embodiment of the invention, the encrypted file is a file type that is recognized by the security application. Specifically, the security application may create encrypted files with a file format different from the clear text format.

In one embodiment of the invention, the encrypted file corresponds to a file, where the metadata for the corresponding file is stored in the metadata directory in a metadata file. For example, the encrypted version of a Microsoft Word file may be of type “.pac” and may only be opened, modified, and deleted using the security application. In the example, the encrypted file corresponds to a file that has a file name “Trip to Thailand.doc”.

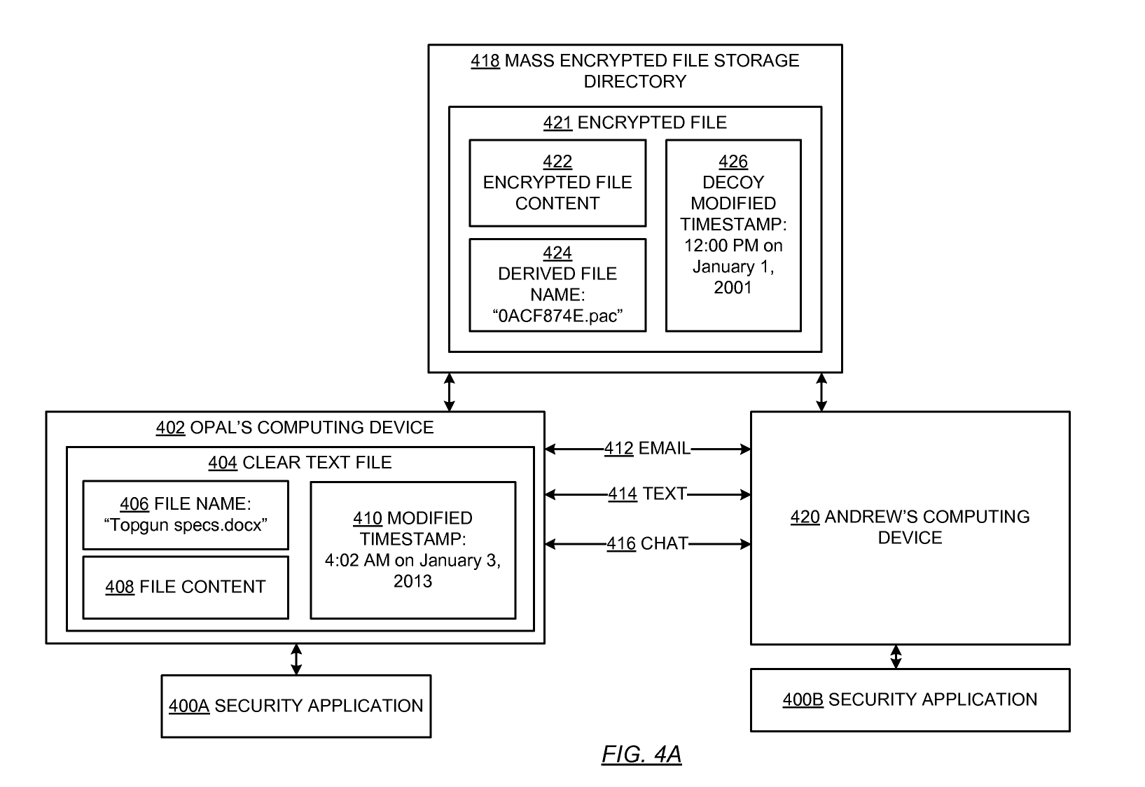

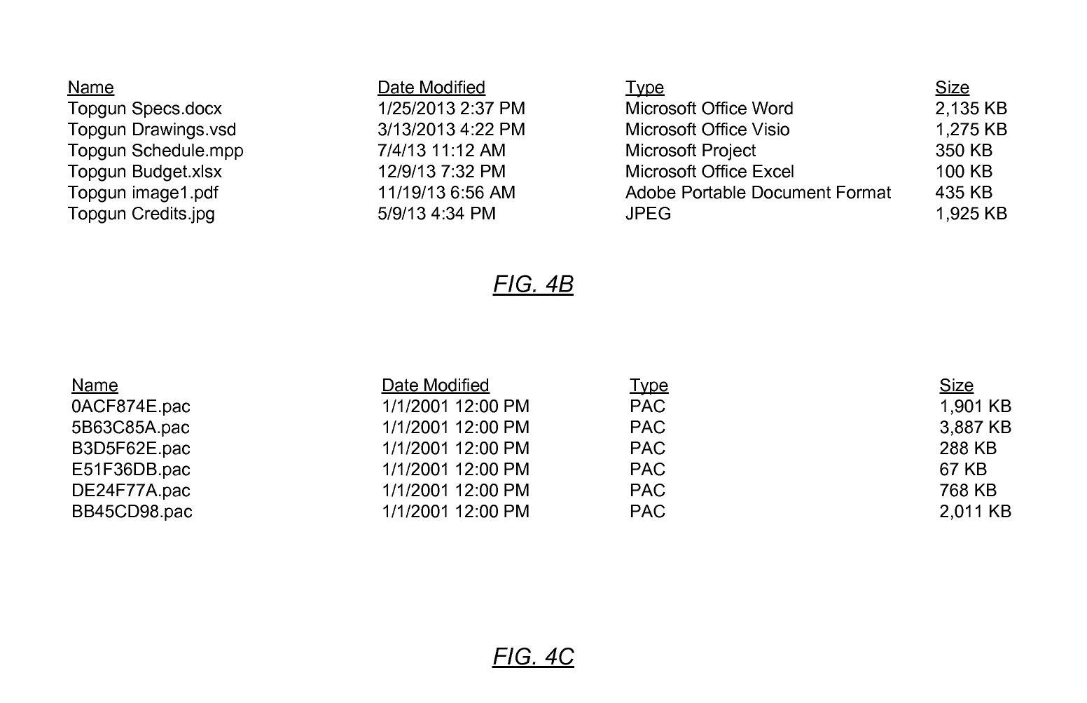

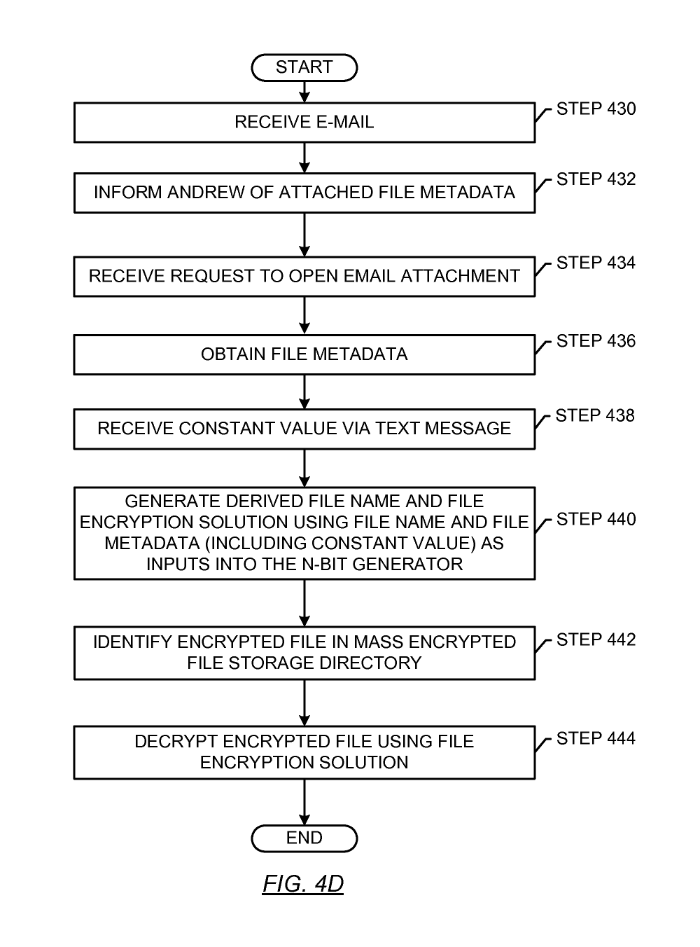

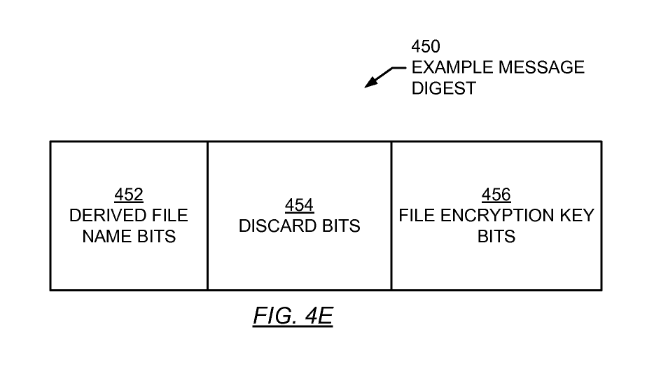

The encrypted file (e.g., 118A, 118X) includes encrypted file content (e.g., 120A, 120X), a derived file name (e.g., 124A, 124X), and decoy metadata (e.g., 122A, 122X). Each of the components is discussed below. In one embodiment of the invention, the encrypted file content (120A, 120X) includes the result of encrypting the entire original file. Said another way, when a file is encrypted in accordance with one or more embodiments of the invention, the encryption module encrypts the file content and the file metadata to obtain the encrypted file content. The security application may then add the decoy metadata (including the derived file name) to make all encrypted files appear similar to other encrypted files. (See e.g., FIGS. 2 and 4C).

Encrypted file content (e.g., 120A, 120X) is any information that is encrypted. Specifically, as discussed above, the file content of a file, by virtue of being encrypted, becomes unreadable. Accordingly, the encrypted file content may appear to be random or pseudo-random.

A derived file name (e.g., 124A, 124X) is a pseudo-random string of characters (e.g., symbols and/or alphanumeric characters) of a pre-defined length. Accordingly, the derived file name may appear indistinguishable from other derived file names in the mass encrypted file storage directory (116). In one embodiment of the invention, the derived file names may be determined by using a random number generator. In another embodiment of the invention, the derived file name may be generated using the n-bit generator. Specifically, the n-bit generator may be used to generate an m-bit message digest where all or a portion of the m-bit message digest is used to generate the derived file name. In one embodiment of the invention, the derived file may be generated by converting all or a portion of the m-bit message digest into textual format using hex or ASCII. For example, bits extracted from a message digest are translated into text using a character encoding scheme. For example, the character encoding scheme may be American Standard Code for Information Interchange (ASCII), Unicode, or the Universal Character Set. The message digest may be translated into text using any character encoding scheme without departing from the invention. In one embodiment of the invention, the encryption key used to encrypt the file along with a bit string used to generate the derived file name for the resulting encrypted file may be obtained from one or more m-bit message digest.

In one embodiment of the invention, the decoy metadata is similar to the file metadata (e.g., 108A, 108X) and may include a created timestamp, a accessed timestamp, a modified timestamp, and the file size. In one or more embodiments of the invention, all of the decoy metadata may be generated by the security application or a related process, except the file size, where the file size corresponds to the actual size of the encrypted file.

In one or more embodiments of the invention, prior to encrypting a file using the encryption module, the file (or a portion thereof) is compressed. The resulting compressed file is then encrypted using the encryption module. In the event that a file (or a portion thereof) is compressed prior to encryption, when the encrypted file is subsequently decrypted (see FIG. 3), the resulting decrypted file must be decompressed in order to obtain the original file.

In one embodiment of the invention, the decoy metadata is identical for each encrypted file in the mass encrypted file storage directory so that the decoy metadata for an encrypted file appears to be indistinguishable from the decoy metadata of other encrypted files. Rather than being completely identical, the aforementioned components may be substantially similar. Thus, the encrypted files associated with the decoy metadata appear to be indistinguishable as well. For example, the created timestamp of each encrypted file in the mass encrypted file storage directory may be a date in the past such as Jan. 8, 2012. By way of another example, if the actual file size of the clear text file is 25 MB, the file size in the decoy metadata may range from 5 to 25 MB. A broader range of file sizes may exist without departing from the scope of the invention.

In one embodiment of the invention, the mass encrypted file storage directory (116) may also include clear text files. In another embodiment of the invention, the mass encrypted file storage directory may be partitioned by encrypted files and clear text files. Alternatively, the clear text files and encrypted files may be stored together. In one embodiment of the invention, the mass encrypted file storage directory (116) may include a partitioning of files for each group of which the user is a member. The mass encrypted file storage directory (116) may be implemented using other file organization schemes without departing from the invention.

In one embodiment of the invention, the mass encrypted file storage directory (116) (or portions thereof) is located on an external device that is accessible to the security application. Examples of external devices include, but are not limited to, a mobile phone, a smart phone, a personal digital assistant, a portable gaming device, a memory device (e.g., any device with non-volatile memory) with a wireless or contactless interface (e.g., a BlueTooth Interface), a memory device (e.g., any device with non-volatile memory) with a wired or contact interface (e.g., a Universal Serial Bus (USB) interface), etc.

In one embodiment of the invention, the mass encrypted file storage directory is located on a cloud computing system. Specifically, the mass encrypted file storage directory (116) includes a large number of encrypted files that appear indistinguishable. Thus, seeking a particular encrypted file becomes more difficult. For example, the mass encrypted file storage directory may be stored on a cloud drive that stores millions of encrypted files. Such a cloud computing system may also store clear text files. Further, the mass encrypted file storage directory may be located on a multi-tenant cloud computing system that is accessible by third-parties (i.e., users and/or systems that are not members (as described above)).

In one or more embodiments of the invention, mass encrypted storage directory may be implemented using network attached storage (NAS), direct attached storage (DAS), a storage area network (SAN) or any combination thereof.

In one or more embodiments of the invention, a member corresponds to a computing device that includes a n-bit generator, one or more interfaces (wired or wireless) to obtain the inputs necessary to perform steps 300-306 in FIG. 3. In such embodiments, the member may then provide the derived file name and the file encryption key to other computing devices that may then perform the remainder of the steps described in FIG. 3.

For example, a mobile phone may include an n-bit generator and one or more interfaces to obtain the inputs necessary to perform steps 300-304. The derived file name and file encryption key may then be displayed on the display of the mobile phone. A user of the mobile device may be then transfer the derived file name and file encryption key into a desktop computer. An application executing on the desktop computer may then access the mass encrypted file storage directory (116) and use the derived file name to obtain the encrypted file. The encrypted file may then be decrypted by the desktop computer using the file encryption key.

In the above example, the mobile phone is the member of the group while the desktop computer is used to offload some of the processing that could otherwise be performed by the mobile phone. Such embodiments enable the member to be any computing device that is able to perform steps 300-304 but such a computing devices does not need to have the additional processing capacity to perform the encryption and decryption.

In one or more embodiments of the invention, the encryption functionality (described in FIG. 2, step 214) and decryption functionality (described in FIG. 3, step 308) may be offloaded to a computing device that is external to the member, while the member may perform all the other steps described in FIGS. 2 and 3.

The following section describes two additional embodiments of the invention. The following examples are not intended to limit the scope of the invention.

### Example 1

Consider a scenario in which a laptop includes the metadata directory, the original file, and an encryption module. Further, the laptop is operatively connected to a mobile phone that includes a n-bit generator and a secrets directory. The laptop is also operatively connected to the mass encrypted file storage directory.

In order to store the original file in the mass encrypted storage directory, an application executing on the laptop provides the mobile phone with (a) a reference (e.g., an ID, pointer, etc.) to a particular secret in the secrets file, and (b) the metadata for the file (or a portion thereof). The mobile phone uses inputs (a) and (b) from the laptop in combination with an n-bit generator to generate a message digest. The message digest is then provided to the laptop. The laptop then proceeds to performs step 208-218 as described in FIG. 2 below.

### Example 2

Consider a scenario in which a laptop includes an encryption module. Further, the laptop is operatively connected to a mobile phone that includes a n-bit generator, a secrets directory, the metadata directory, the original file. The laptop is also operatively connected to the mass encrypted file storage directory.

In order to store the original file in the mass encrypted storage directory, the mobile phone performs steps 200-216 in FIG. 2. In this example, once the encrypted file is generated, the original file is deleted or otherwise removed from the mobile phone. The resulting encrypted file is then transferred to the laptop. The laptop then proceeds to perform step 218 as described in FIG. 2 below.

FIGS. 2 and 3 show flowcharts in accordance with one or more embodiments of the invention. While the various steps in the flowchart are presented and described sequentially, one of ordinary skill will appreciate that some or all of the steps may be executed in different orders, may be combined or omitted, and some or all of the steps may be executed in parallel. In one embodiment of the invention, the steps shown in any of the flowcharts may be performed in parallel with the steps shown in any of the other flowcharts.

FIG. 2 shows a flowchart for protecting and storing a file in accordance with one or more embodiments of the invention.

In Step 200, a file is received. Specifically, a file is received to be processed and stored by the security application. In one embodiment of the invention, general files or other data related to the file are also identified.

In one embodiment of the invention, the user may select a file using the user interface of the security application. Alternatively, the security application may be integrated into another program and executed by the user when a file is selected. For example, if the security application is integrated with an email application, the security application may be executed when the user clicks on a file to be emailed as an attachment or in reverse will decrypt an encrypted file received attached to an email. In another example, if the file is marked as confidential or sensitive, then the security application will encrypt it before it is stored (anywhere it is stored).

In Step 202, the file metadata is obtained from the file, where the file metadata includes the file name and the other file metadata (as described above)

In Step 204, the file metadata is stored as a metadata file in the metadata directory. As discussed above, the metadata file may include the file metadata from file received in step 200 as well as one or more additional constants and/or search parameters (as described above). In one embodiment of the invention, portions of the file metadata may be copied from the file and then stored. For example, if the file metadata includes the file size, the accessed timestamp, and created timestamp, the accessed timestamp and created timestamp may be identified, copied, and stored. Thus, all or selected portions of the file metadata associated with the file (obtained in Step 200) are copied and stored. In one embodiment of the invention, the file metadata that is ultimately stored in the metadata directory may not include the (original or native) file size of the file obtained in Step 200.

In Step 206, a message digest is generated using the file metadata, a shared secret(s) as inputs into the n-bit generator (136). Specifically, using, file metadata from Step 202, a shared secret (130X) from the secrets file (128X) stored in the security directory (126) the n-bit generator generates a message digest. In one embodiment of the invention, all or any portion of the file metadata may be used as inputs into the n-bit generator.

In one embodiment of the invention, the shared secret is known to the members of a group and may be used as an input to the n-bit generator. For example, if there are three members in a group, each member stores a shared secret in their security directory 126 that may be used as an input to the n-bit generator when generating a message digest. The shared secret(s) is the only piece that an attacker could not find by examining the files in the metadata directory.

As discussed above, the n-bit generator generates the message digest by applying the operations of the n-bit generator to the input values. In one embodiment of the invention, any combination of inputs above may be used to generate the message digest using the n-bit generator. Further, the inputs to the n-bit generator may include any information relating to the file.

In Step 208, the file encryption key and derived file name are obtained from the message digest. Specifically, the encryption module identifies a portion of the message digest corresponding to a derived file name and a portion of the message digest corresponding to a file encryption key. For example, in a 512-bit message digest, bits in bit positions 0-255 may correspond to the file encryption key and bits in bit positions corresponding to 256-383 may correspond to the derived file name, and the final 128 bits may remain unused. In the example, the security application extracts the file encryption key by obtaining 0-255 bits and extracts the derived file name by obtaining the next 128 bits the remaining bits are deleted or destroyed. In one embodiment of the invention, no remnants of any of the bits remain once the security application finishes performing FIG. 2 for a given file.

In Step 210, a determination is made whether a naming conflict exists in the mass encrypted file storage directory. Specifically, a determination is made whether the derived file name matches an existing file name in the security directory. If a file naming conflict exists, the naming conflict is corrected in Step 212. Different techniques may be used to correct the naming conflict. For example, if a constant value is used to generate the derived file name, then the constant value may be modified prior to repeating step 206. The name conflict may also be addressed by changing any of the inputs to the n-bit generator. For example, if the original file is resaved, the new timestamp on the original file (which makes up part of the file metadata) may then be used in generating the new message digest in step 206. Other methods to correct the naming conflict may be used without departing from the scope of the invention.

In Step 214, the file (i.e., the file received in Step 200) is encrypted using the file encryption key. Specifically, the encryption module applies an encryption algorithm to the file using the file encryption key obtained in Step 208. Thus, the content in the encrypted file may be protected even if the encrypted file is identified. In one embodiment of the invention, the file, including the file name, other file metadata, and file content, is encrypted to create encrypted file content. In one embodiment of the invention only portions of the file metadata and the file content are encrypted.

In Step 216, an encrypted file is generated that includes the decoy metadata and the encrypted file content. Specifically, the decoy metadata includes the derived file name (obtained in Step 208) as well as other metadata that is generated or otherwise obtained and then used to generate the encrypted file. In one embodiment of the invention, the decoy metadata is generated using a predetermined value. The decoy metadata may be determined as a function of the format and size of the encrypted file.

Alternatively or additionally, the decoy metadata (excluding the derived file name) may be assigned values within a predetermined range of values. In another embodiment of the invention, the decoy metadata may be randomly generated. In one embodiment of the invention, the generated decoy metadata (excluding the derived file name) is identical across all encrypted files in the mass encrypted file storage directory. Specifically, the decoy metadata (excluding the derived file name) is predetermined to be a particular value across all encrypted files in the mass encrypted file storage directory. In another embodiment of the invention, the decoy metadata (excluding the derived file name) of all encrypted files in the mass encrypted file storage directory is within a predetermined range. For example, the decoy metadata may include an accessed timestamp that is a date in the past. In the example, all of the encrypted files may include an accessed timestamp of 3:42 pm on Jan. 12, 2012. Thus, the encrypted files may not be distinguished based on the last accessed timestamp alone. Alternatively, the timestamp may be randomly assigned a date in a range of values such as Jan. 27, 2012 to Feb. 12, 2012. All content in the decoy metadata, except the encrypted file size, may be generated by or otherwise obtained by the security application. The file size of the encrypted file corresponds to the actual size of the encrypted file.

In one or more embodiments of the invention, the derived file name and decoy metadata conform to the requirements of the file manager that maintains the mass file encrypted storage.

In Step 218, the encrypted file is stored in the mass encrypted file storage directory.

In one embodiment of the invention, prior to storing the encrypted file in the mass encrypted file storage directory, search parameters may be added to the decoy metadata. The search parameters may include all or a subset of search parameters that are added to the corresponding metadata file. The mass encrypted storage directory may be subsequently searched using the search parameters. Such searches may be used to identify various trends within the encrypted file directory. Said another way, the inclusion of the search parameters within the encrypted files allows information to be extracted from the encrypted files without compromising the security of the content in the encrypted files.

Those skilled in the art will appreciate that while the search parameters included within the decoy metadata of the encrypted files correspond to non-decoy metadata (i.e., the search parameters are related to (or included a copy of a portion of) the encrypted file content within the encrypted file, the search parameters typically do not include sufficient information to decrypt the encrypted file, or otherwise extract information from the encrypted file (other than the information that is present in the search parameters).

FIG. 3 shows a flowchart for retrieving and decrypting an encrypted file in accordance with one or more embodiments of the invention. In Step 300, a file name (e.g., 104X in FIG. 1) is selected or received. Specifically, a request to retrieve a file associated with the file name (e.g., 104X in FIG. 1) is selected or received. The request may be received from the user using the member, an application executing on the member or executing on a computer system connected to the member, another member, etc.

For example, the user may start the security application and select a file to start sharing with other members in a group. Prior to the selection of the file to share, the file has been encrypted and stored in the Mass Encrypted File Storage Directory (116) in accordance with FIG. 2. If the user (that originally stored the file in the mass encrypted filed storage directory) wants to retrieve and decrypt the file, s/he would go to the Metadata Directory (100) and select the file (104X) and proceed with the remainder of steps in FIG. 3.

If the user wants to share the file with members in a group, s/he would select the group using the security application (134), select a communication channel(s) (e.g. email, text, direct connection, etc.) over which to communicate with the selected group, and then select the file (104X) from the Metadata directory (100). In response, the security application may access the connection information for other members of the group, the file to be shared, and any information associated with the file. The information may be sent or provided to different members using different communication channels (e.g., some members may receive an email and others may receive a text).

As a second example, the user may use an application (e.g., a email application, a chat application, an internet browser) to start a communication session with another user to transmit information necessary to perform the Steps in FIG. 3. The security application may intercept the user's connection request, identify the members of the group corresponding to the recipient users, and invite the other members of the group to share files in the communication session using the connection information for the other members. Further, the security application may then access the file to be shared and any information required to perform the steps in FIG. 3

As a third example, the request for file sharing may be initiated by the security application receiving an invite to share files from another member of the group. In response, the security application may notify the user that file sharing is requested in accordance with one or more embodiments of the invention.

Regardless of how the file name is obtained or received, neither the original unencrypted file (e.g., the file in Step 200) or the encrypted file is directly transmitted between members. Instead, only the file metadata (or portions thereof) is communicated between members.

In one embodiment of the invention, when a first member of a group is attempting to share a file with a second member of the group, the first member may perform step 300 in order to identify the appropriate file metadata to send to the second member in order for the second member to perform steps 302-308.

In Step 302, file metadata (e.g., Metadata File (106X) in FIG. 1) is received or otherwise obtained. Specifically, the file metadata associated with the file is received. Similar to Step 432, the file metadata is received when the user interacts with the security application or another application interacts with the security application. In one or more embodiments only portions of the file metadata that are required to perform the steps in FIG. 3 are transmitted or otherwise communicated between members of the group. In one embodiment of the invention, different portions of the file metadata may be transmitted between the various members of the group using different communication channels (e.g., text, email, etc.)

In Step 304, a derived file name and encryption key are generated or otherwise obtained using the, file metadata and a shared secret(s). Specifically, the n-bit generator generates a message digest identifying the derived file name and the file encryption key using the shared secret and file metadata (or a portion thereof) as inputs. In one embodiment of the invention, the shared secret was previously generated and stored in a location that is accessible to the n-bit generator. Further, the n-bit generator may receive information about which of the shared secrets to use as input to the n-bit generator. The selection of the particular shared secret(s) may depend on: the group to which the members belong, the particular file being requested, any other factor, or any combination thereof.

In one embodiment of the invention, one or more shared secret(s) may be obtained by generating a message digest with inputs known only to the members of the group. The message digest may then be used to identify the secrets file name and secrets encryption key. Using the secrets file name and secrets encryption key, the secrets file may be decrypted and the secret may be obtained. For example, if members of a group decide on a group connect name of “Bazinga,” then the group connect name may be used as input into the n-bit generator. In the example, the secrets file name and secrets encryption key may then be extracted from the generated message digest and used to decrypt the secrets file. With the secrets file decrypted, the secret may be obtained.

The encryption module extracts the aforementioned components from the message digest. Generating the message digest and extracting the file encryption key may be performed as discussed above with reference to Steps 208 in FIG. 2. In one embodiment of the invention, the shared secret may also be an input into the n-bit generator. Alternatively or additionally, any information related to the file may be used as an input into the n-bit generator.

In Step 306, a determination is made whether the derived file name is found in the mass encryption file storage directory. If a matching file name is found, then the encrypted file is identified. If the matching file name is not found, then the received file metadata and constant value may be incorrect. The security application may allow the user to re-submit the file metadata and constant value. Alternatively, the security application may deny access to the user.

In Step 308, the encrypted file is obtained and decrypted using the file encryption key. Specifically, the encrypted file is retrieved and the encryption algorithm is applied to the encrypted file (i.e., the file identified in Step 306) using the file encryption key to decrypt the file.

In one embodiment of the invention, the decrypted file is presented to the user on the member via the user interface. The decrypted file may be opened or accessed by other applications in the member.

FIGS. 4A, 4B, 4C, 4D, and 4E show an example in accordance with one or more embodiments of the invention. This example is not intended to limit the scope of the invention or the claims.

FIG. 4A shows an exemplary system in accordance with one or more embodiments of the invention. In the following example, consider the scenario in which Opal and Andrew want to share a file (404) via an email application (412). Opal may also share the file (404) using other communication channels (e.g., text (414) and chat (416)). Those skilled in the art will appreciate that other forms of communication may be used without departing from the invention. Opal's computing device (402) is a computer system that includes an email application (not shown). Opal's computer system executes the security application (400A). Opal's computing device (402) is referred to below as the originating (sending) member. Similarly, Andrew's computing device (420) is a smart phone that has an email application (not shown) and a security application (400B). Andrew's smart phone is referred to below as the answering (receiving) member. Further, in the example, the mass encrypted file storage directory (418) is hosted on Google® Drive and is a multi-tenant SAN open to the public.

In the example, Opal opens her email application on her computer system. Opal may select a file from a file directory (e.g., “My Documents” directory) that includes several clear text files (see e.g., FIG. 4B). Opal selects the clear text file (404 in FIG. 4A) named “Topgun Specs.docx” to share with Andrew via email (412 in FIG. 4A). The security application (400A in FIG. 4A) intercepts the request to share the clear text file (404 in FIG. 4A) that includes file content (408 in FIG. 4A). The security application then identifies that the file name (406 in FIG. 4A) of the file is “Topgun Specs.docx” and the modified timestamp (410 in FIG. 4A) of the file is 4:02 AM on Jan. 3, 2013. Using a random alphanumeric character generator, the security application selects a constant value (not shown) of “ad73kgs” for the file. Using the file name (406 in FIG. 4A), modified timestamp (410 in FIG. 4A), and constant value associated with the file, a message digest is generated.

Continuing with FIG. 4A, the selected clear text file (404) is encrypted using an encryption key obtained from the message digest. The encrypted file (421) is then stored in the multi-tenant mass encrypted file storage directory (418) under the derived file name (424) of “0ACF874E.pac.” As predetermined by the security application, the decoy modified timestamp (426) of the encrypted file is 12:00 PM on Jan. 1, 2001. Accordingly, the encrypted file includes the decoy modified timestamp (426).

Referring to FIG. 4C, the encrypted file “0ACF874E.pac” is stored along with many other files (which may be encrypted) with similar derived file names. Accordingly, the encrypted file “0ACF874E.pac” appears to be indistinguishable in relation to the other files. Further, even with knowledge of the file metadata of the clear text file “Topgun Specs.docx,” seeking out the corresponding encrypted file “0ACF874E.pac” becomes difficult. In the example, even if a malicious user is aware that the modified timestamp of the clear text file is 1/25/2013 at 2:37 PM, the corresponding encrypted file would not be apparent because all of the encrypted files have identical decoy modified timestamps of 1/1/2001 at 12:00 PM.

Returning to FIG. 4A, Opal sends the Metadata File (106X) of the clear text file (404) to Andrew via email. The Metadata File (106X) includes but is not limited to the File Name (406) and modified timestamp (410). The email application sends the email to Andrew. Andrew selects to open the Metadata File (106X) attached in the email received from Opal. As described in FIG. 4D, the security application (400B) on Andrew's computing device (420) intercepts (recognizes) the request to open an encrypted file (421) in the multi-tenant mass encrypted file storage directory (418).

FIG. 4D shows a flowchart from the perspective of the answering member (i.e., Andrew's smart phone). Starting with FIG. 4D, in Step 430, the answering member (e.g., Andrew's smart phone) receives an email with attached file metadata via an email application.

In Step 432, the answering member informs Andrew of the attached metadata file. Specifically, the security application on the smart phone may have a notification mechanism, such as an icon, ring tone, or other notification mechanism, that informs Andrew that a request to share a file is received. At this stage, Andrew may decide whether to accept, postpone or reject opening the shared file. If Andrew rejects the file share request, then the answering member ends the security application (400B in FIG. 4A).

However, if Andrew accepts the file share request, then a request to open the email attachment is sent. Accordingly, in Step 434, the security application receives a request to open the file associated with the metadata file attached in the email from Andrew.

In Step 436, the metadata file is obtained from the email attachment. Referring to Step 438, as discussed above, portions of the metadata (e.g., a constant value) may be transmitted to a member using different communication channels, in the example, the answering system receives the constant value “ad73kgs” via text message (414 in FIG. 4A) from the originating system. In response to this, Andrew authorizes inputting the constant value into the user interface of the security application (400B in FIG. 4A) when prompted.

In Step 440, the n-bit generator executing on the answering system generates a message digest using the file metadata (including the constant value) as inputs. Specifically, a message digest is generated and the file name and file encryption key are extracted. For example, the n-bit generator may XOR, file metadata to create a message digest. For example, the generated message digest may correspond to message digest (450) in FIG. 4E. Referring to FIG. 4E, a message digest may include derived file name bits (452), discard bits (454), and file encryption key bits (456). As described above, the message digest may also include algorithm selection bits (not shown) that may be used to identify the encryption/decryption algorithm to use to decrypt the encrypted file.

The derived file name bits (452) are bits in the message digest that may be translated into text, as shown below. Specifically, the derived file name (452) is the file name of the encrypted file as stored in the multi-tenant mass encrypted file storage directory.

Discard bits (454) are bits that are ignored when creating the encryption solution. Specifically, discard bits are bits that prevent the nefarious user or computer system from understanding the (entire/full) message digest. By having discard bits, the nefarious user or computer system may be unable to ascertain which bits are actually used for the encryption key.

The file encryption key bits (456) are bits that are used to first encrypt the file prior to storage of the file in the multi-tenant mass encrypted file storage directory and later to decrypt the file after it is retrieved from the multi-tenant mass encrypted file storage directory.

In the example, the extracted derived file name bits and extracted file encryption key are extracted by the answering member. The file name may be, in the example, the first 32 bits of the message digest and the file encryption key may be, in the example, the last 128 bits of the message digest.

The extracted derived file name bits (not shown), as denoted by hexadecimal notation, from the message digest might be 3041434638373445. As pre-configured in the security application, the security application creates encrypted files with the file extension “.pac.” Further, the security application uses the ASCII character encoding scheme to translate extracted derived file name bits into text. Accordingly, the derived file name generated using bits extracted from the message digest is “0ACF874E.pac.” Similarly, the extracted file encryption key bits (not shown), as denoted by hexadecimal notation, from the message digest are 8A5C3E5B.

Returning to FIG. 4D, in Step 442, based on the extracted derived file name, the answering member identifies the file in the multi-tenant mass encrypted file storage directory. Because the message digest is a pseudo-random bit string, the derived file name is also pseudo random and can only be identified if the file name, file metadata, and constant value are correct. Thus, by finding the derived file name, the security application may decrypt the encrypted file. In the example, the encrypted file associated with the derived file name “0ACF874E.pac” is identified.

In Step 444, the answering member decrypts the identified encrypted file using the file encryption key. Specifically, the answering member uses the file encryption key and a symmetric encryption algorithm to decrypt the encrypted file. Using the file encryption key 8A5C3E5B as extracted from the message digest, the security application decrypts the encrypted file associated with the file name “0ACF874E.pac.”

The decrypted file, clear text file name, and file metadata are displayed on the answering member via user interface. Andrew may now open the decrypted file using another application on his smart phone.

The following example describes another embodiment of the invention. More specifically, the following example describes how electronic health records (EHRs) may be secured using one or more embodiments of the invention. The invention is not limited to the following example.

For purposes of this example, an EHR includes a single file or multiple files, where each of the files includes medical information about the patient. For example, the EHR for a given patent may include information that is collected during a routine physical, information that is recorded when the patient has a medical procedure, information that is recorded anytime the patient sees a healthcare provider. The files may include any combination of text, images, video, audio, etc. Non-limiting examples of the types of information that may be included in an EHR include x-rays, results of a blood panel, doctor's notes from a physical, EKG results, lab test results, age, height, weight, blood type, drug allergies, food allergies, currently prescribed medications, current medical conditions, emergency contact information, health insurance information, a picture of the patient, etc.

In one embodiment of the invention, the EHRs do not include any identifying information about the patient (e.g., the EHRs do not include the patient's name, date of birth, social security number, etc.). Rather, the EHRs for a given patient include an ID (which may be a number, a character string, or an alphanumeric string) where only the appropriate healthcare providers are able to determine who the actual patient is using the ID.

Consider a scenario in which each patient has “patient metadata”, where the patient metadata that includes general information about the patient that healthcare providers (e.g., doctors, nurses, specialists, medical service providers, hospitals, labs, surgical centers, emergency rooms, emergency medical technicians, pharmacist, etc.) need to know to identify the particular patient. This information may include, for example, the full legal name, sex, date of birth, social security number, blood type, etc. Each patient is also associated with one or more shared secrets.

Using one or more embodiments of the invention, an EHR for a given patient may be stored as one or more encrypted files in a mass encrypted file storage directory, where each of the files in the EHR for the patient is encrypted using an m-bit result generated in accordance with FIG. 2 above. In this example, the inputs to the n-bit generator include, at least, all or some portion of the patient metadata and the shared secret(s) for the patient.

In order to access one or more the EHRs for a given patient, the healthcare provider needs to have the specific portions of the patient metadata as well as the shared secret(s) for the patient. The healthcare provider may then perform the steps shown in FIG. 3 to access the particular EHRs for the patient.

In another embodiment of the invention, each file in the set of the EHR for a given patient may be encrypted using at least (i) all or a portion of the patient metadata, (ii) the shared secret(s) for the healthcare provider. In this example, all EHR for a given healthcare provider are secured with the same shared secret(s) but different patient metadata. In another example, each patient may have patient specific shared secrets; such that each EHR is protected by a patient unique shared secret.

In another embodiment of the invention, each file in the set of the EHR for a given patient may be encrypted using at least (i) all or a portion of the patient metadata, (ii) the shared secret(s) for the patient, and (iii) a constant value, where the constant value may be specific to: the healthcare provider, the type of information in the particular file (e.g., lab results, etc.), etc. By using the constant value, access to the various files in the EHR may be protected at more granular level.

In another embodiment of the invention, each file in the set of the EHR for a given patient may be encrypted using at least (i) a shared secret(s) for the patient and (ii) a specific portion of the patient metadata, where the particular patient metadata used for a given file may be specific to: the healthcare provider, the type of information in the particular file (e.g., lab results, etc.), etc. By using the different portions of the patient metadata, access to the various files in the EHR may be protected at a more granular level.

Consider another example in which one or more embodiments of the invention may be used to provide EHR for a patient that is in need of emergency medical attention but is unconscious. In this scenario, the patient may have a mobile phone that includes the patient's metadata. When an EMT arrives, the EMT may obtain the patient's metadata from the patient's mobile phone and then use a shared secret that was previously shared with the EMT in order to obtain one or more portions of the patient's EHR from the mass encrypted file storage directory.

Consider another example in which one or more embodiments of the invention may be used to provide EHR for a patient that is in need of emergency medical attention but is unconscious. In this scenario, the patient may have previously stored a specific emergency medical information file as part of their EHR in the mass encrypted file storage directory. The message digest that is used to obtain the encryption key and derived file name uses patient metadata as well as shared secret, where the shared secret is a global shared secret that is used by all EMTs for all patients. In this example, the global shared secret is only used to secure the emergency medical file for a given patient but not any other portions of the patient's EHRs.

When an EMT arrives, the EMT may obtain the patient's metadata from the patient's mobile phone and then use the global shared secret to obtain the patient's emergency medical information from the mass encrypted file storage directory. If the EMT needs additional EHRs for the patient, the EMTs may obtain emergency contact information for the patient or contact information for the patient's primary care physical from the emergency patient information. The EMT may then contact one or the aforementioned individuals in order to obtain the patient's shared secret in order for the EMT to obtain other EHRs for the patient. The same process may be used by other healthcare providers that are treating the patient.

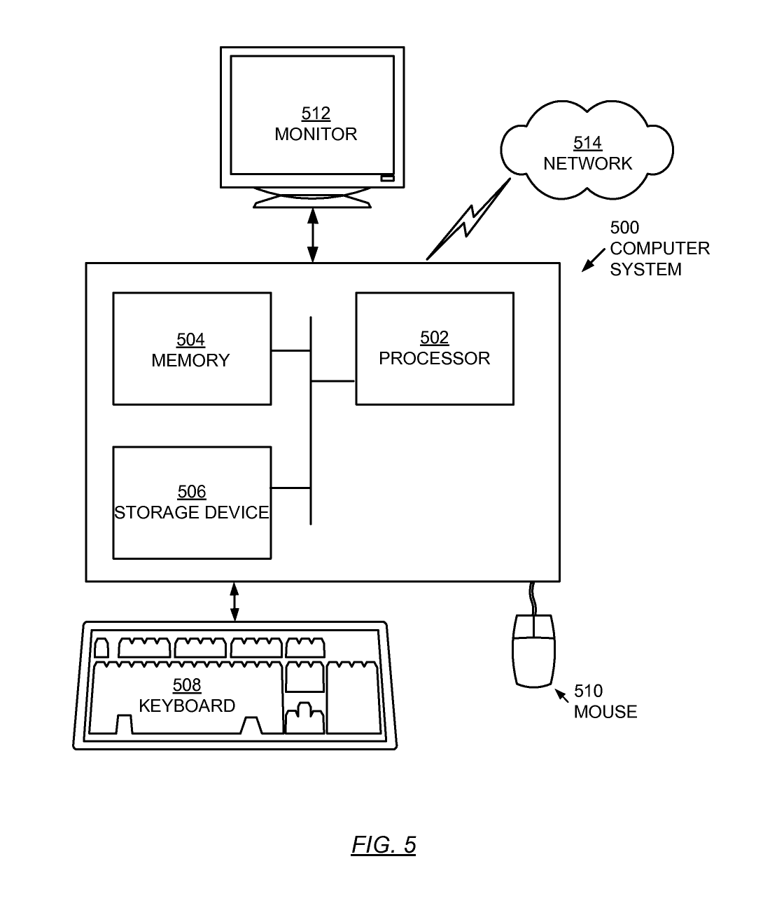

Embodiments of the invention may be implemented on virtually any type of computer system regardless of the platform being used. The computing device may be the computer system, execute on the computer system, be an external device of the computer system, operate as a collaboration of two or more physical devices operating interdependently, etc. For example, as shown in FIG. 5, a computer system (500) includes one or more processor(s) (502), (which may include any type of processor including graphics processors, CPUs, etc.), associated memory (504) (e.g., random access memory (RAM), cache memory, flash memory, etc.), an internal and/or external storage device (506) (e.g., a hard disk, an optical drive such as a compact disk drive or digital video disk (DVD) drive, a flash memory stick, universal serial bus (USB) drive, smart card, smart phone, etc.), and numerous other elements and functionalities typical of today's computers (not shown). The computer system (500) may also include input means, such as a keyboard (508), a touch screen (512), a mouse (510), or a microphone (not shown). Further, the computer system (500) may include output means, such as a monitor (512) (e.g., a liquid crystal display (LCD), a plasma display, or cathode ray tube (CRT) monitor). The computer system (500) may be connected to a network (514) (e.g., a local area network (LAN), a wide area network (WAN) such as the Internet, or any other type of network, public or private) via a network interface connection; wired or wireless (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

In one or more embodiments of the invention, if there are multiple processors in a computing device that is performing decryption or encryption in accordance with one or more embodiments of the invention, then such processing may be performed in the following manner in accordance with one or more embodiments of the invention. Specifically, each processor may be designated to perform one type of encryption algorithm and each of the processors may be associated with a number or other label. The computing device may then use a first processor to encrypt a first datum to generate a first encrypted datum. The first encrypted datum may then be further encrypted using a second encrypted datum. This process may be repeated until the original datum has be encrypted N number of times, where N≧2. The encryption algorithms used by each processor may be the same or different based on the implementation of the invention. Further, the order in which the processors are used (i.e., the order in which the encryption algorithms are applied) may be determine a priori by the computing device or may be provided to the computing device from another computing device.

If a given piece of datum is encrypted using the particular order or encryption algorithms, then the decryption process occurs in the reverse order on the computing device that received the encrypted datum (which may include datum that is encrypted multiple times).

If an encrypted file is encrypted using multiple algorithms, then order in which the encryption algorithms are applied may be determined at the time group is created. For example, the members of the group agree to encrypt files using various encryption algorithms in a particular order. Further, in such embodiments the file encryption keys used for encryption or decryption may be obtained from a single or multiple message digests depending on the implementation of the invention.

Computer readable program code to perform embodiments of the invention may be stored on a computer readable medium such as a compact disc (CD), a diskette, a tape, physical memory, or any other physical computer readable storage medium that includes functionality to store computer readable program code to perform embodiments of the invention. In one embodiment of the invention the computer readable program code, when executed by a processor(s), is configured to perform embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for securing electronic health records (EHRs), comprising:
receiving an EHR for a patient;
obtaining patient metadata for the patient;
generating a message digest using at least a portion of the patient metadata;
extracting, from the message digest, a derived file name and a file encryption key;
encrypting, using the file encryption key, the EHR to obtain encrypted file content;
associating the encrypted file content with the derived file name and decoy file metadata to obtain an encrypted EHR; and
storing the encrypted EHR in a file directory.

2. The method of claim 1, wherein generating the message digest further comprises using a shared secret, wherein the patient and at least one healthcare provider has access to the shared secret.

3. The method of claim 1, wherein generating the message digest further comprises using a shared secret, wherein the shared secret is one selected from a group consisting of a shared secret unique to the patient and a shared secret unique to a healthcare provider.

4. The method of claim 1, wherein patient metadata comprises general information about the patient that is used by healthcare providers to identify the patient.

5. The method of claim 1, wherein the EHR does not include any information to directly identify the patient.

6. The method of claim 1, wherein the EHR does not include any information that is present in the patient metadata.

7. The method of claim 1, wherein the EHR comprises at least one selected from a group consisting of lab results, test results, doctor's notes, and x-rays.

8. The method of claim 1, wherein the decoy file metadata is a randomly selected value within a predetermined range of values.

9. The method of claim 1, further comprising:
storing the file metadata in a metadata directory, wherein the metadata directory is physically separate from the file directory.

10. The method of claim 9, further comprising:
storing at least one search parameter with the file metadata.

11. The method of claim 10, wherein the at least one search parameter comprises a copy of a portion of the EHR.

12. The method of claim 10, wherein the at least one search parameter is derived using at least a portion of the EHR.

13. A computing device, comprising:
a processor;
a memory; and
software instructions stored in memory for causing the computing device to:
receive an EHR for a patient;
obtain patient metadata for the patient;
generate a message digest using at least a portion of the patient metadata;
extract, from the message digest, a derived file name and a file encryption key;
encrypt, using the file encryption key, the EHR to obtain encrypted file content;
associate the encrypted file content with the derived file name and decoy file metadata to obtain an encrypted EHR; and
store the encrypted EHR in a file directory.

14. A method for obtaining an electronic health record (EHR) for a patient, comprising:
obtaining a portion of patient metadata;
generating a message digest using at least the portion of the patient metadata;
extracting from the message digest, a derived file name and a file encryption key;
obtaining an encrypted EHR from a file directory using the derived file name; and
decrypting the encrypted EHR to obtain the EHR using the file encryption key.

15. The method of claim 14, wherein obtaining at least a portion of the patient metadata comprises obtaining at least the portion of the patient metadata from a patient's mobile device.

16. The method of claim 15, wherein the message digest is generated on a healthcare provider's computing device.

17. The method of claim 14, wherein generating the message digest further comprises using a shared secret, wherein the shared secret is one selected from a group consisting of a shared secret unique to the patient and a shared secret unique to a healthcare provider.

18. The method of claim 14, wherein generating the message digest further comprises using a shared secret, wherein the patient and at least one healthcare provider has access to the shared secret.

19. The method of claim 14, wherein the EHR does not include ones selected from a group consisting of any information to directly identify the patient and any information that is present in the patient metadata.

20. A computing device, comprising:
a processor;
a memory; and
software instructions stored in memory for causing the computing device to:
obtain a portion of patient metadata;
generate a message digest using at least the portion of the patient metadata;
extract from the message digest, a derived file name and a file encryption key;
obtain an encrypted EHR from a file directory using the derived file name; and
decrypt the encrypted file to obtain the EHR using the file encryption key.
